(19) United States
(12) Patent Application Publication
(10) Pub. No.: US 2013/0286331 A1
(43) Pub. Date: Oct. 31, 2013

(54) Liquid Crystal Display Module and Liquid Crystal Display Device

(71) Applicants: Shyh-Feng Chen, Shenzhen (CN); Je-Hao Hsu, Shenzhen (CN); Ming-hung Shih, Shenzhen (CN); Chengcai Dong, Shenzhen (CN)

(72) Inventors: Shyh-Feng Chen, Shenzhen (CN); Je-Hao Hsu, Shenzhen (CN); Ming-hung Shih, Shenzhen (CN); Chengcai Dong, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/519,310

(22) PCT Filed: May 24, 2012
(86) PCT No.: PCT/CN2012/075977

§ 371 Date: Jun. 26, 2012

(30) Foreign Application Priority Data
Apr. 27, 2012 (CN) 201210129142.9

(51) Int. Cl. G02F 1/1335

(52) U.S. Cl. 349/106

(57) ABSTRACT

The present invention discloses a liquid crystal display device and liquid crystal display module thereof. The liquid crystal display module includes a color filter substrate, a thin film transistor substrate and seal. The thin film transistor substrate and the color film substrate are disposed oppositely, and the seal is disposed between the thin film transistor substrate and the color film substrate. The color filter substrate comprises a first glass substrate and black matrix. The seal comprises a first end part contacting the color filter substrate. No black matrix is disposed between the first end part and the color filter substrate, and the first end part is disposed as a shade structure. The liquid crystal display module and liquid crystal display device of the present invention provide the advantages of convenience for seal curing, facilitating narrow border design, and avoiding aggravating drive signal delay.

### BACKGROUND OF THE INVENTION

1. Field of the Invention

The present invention relates to the field of liquid crystal displaying techniques, and in particular to a liquid crystal display module and a liquid crystal display device based on the liquid crystal display module.

2. The Related Arts

Due to the advantages of low radiation, reduced thickness, light weight, and low power consumption, the liquid crystal display devices find wide applications in the field of displaying for cell phone, personal digital assistant (PDA), notebook PC, PC and TV.

The known liquid crystal display module usually comprises a thin film transistor (TFT) substrate, a color filter (CF) substrate, a liquid crystal layer and seal. The thin film transistor substrate and the color filter substrate are disposed oppositely, and the liquid crystal layer is sandwiched between the thin film transistor substrate and the color filter substrate, sealed by the seal. The color filer substrate further comprises black matrix.

Currently, the narrow border becomes a new trend for liquid crystal display module. One of the designs is to dispose the deal behind the black matrix to save the border space on the color filter substrate side. However, because the seal must use UV for curing after coating, UV light cannot shine from the color filter substrate side when the seal is under the black matrix, and the UV light must shine from the thin film transistor side. Because metal routes are usually disposed under the seal on the thin film transistor side, slits must be made on the metal routes to allow the UV light pass, which leads to the resistance increase of metal routes and aggravating the delay of drive signal.

### SUMMARY OF THE INVENTION

The technical issue to be addressed by the present invention is to solve the problem of inconvenience seal curing on narrow border liquid crystal display module.

The present invention discloses a liquid crystal display module, which comprises: a color filter substrate, a thin film transistor substrate and seal. The thin film transistor substrate and the color film substrate are disposed oppositely, and the seal is disposed between the thin film transistor substrate and the color film substrate. The color filter substrate further comprises a first glass substrate and a black matrix. The seal further comprises a first end part contacting the color filter substrate. No black matrix is disposed between the first end part and the color filter substrate, and the first end part is disposed as a shade structure.

According to a preferred embodiment of the present invention, the seal comprises a second end part corresponding to the first end part, and seal body located between the first end part and the second end part; and the second end part contacts the thin film transistor substrate.

According to a preferred embodiment of the present invention, the second end part and the seal body are of shade structure.

According to a preferred embodiment of the present invention, at least one of the second end part and the seal body is of transparent structure.

According to a preferred embodiment of the present invention, the thin film transistor substrate comprises a second glass substrate and peripheral metal routes located between the second glass substrate and the second end part.

According to a preferred embodiment of the present invention, the color filter substrate comprises a first active area, and the black matrix is located between the first active area and the first end part.

According to a preferred embodiment of the present invention, black matrix and the first end part contact each other directly, or are disposed oppositely with spacing.

According to a preferred embodiment of the present invention, the color filter substrate comprises a transparent conductive layer, the transparent conductive layer is disposed directly on surface of the first glass substrate, and the first end part directly contacts the transparent conductive layer.

According to a preferred embodiment of the present invention, the first end part is doped with black dye.

The present invention discloses a liquid crystal display module, which comprises: a color filter substrate, a thin film transistor substrate and seal. The thin film transistor substrate and the color film substrate are disposed oppositely, and the seal is disposed between the thin film transistor substrate and the color film substrate. The color filter substrate further comprises a first glass substrate and a black matrix. The thin film transistor substrate comprises a second glass substrate and peripheral metal routes located between the second glass substrate and the second end part. The seal further comprises a first end part contacting the color filter substrate. No black matrix is disposed between the first end part and the color filter substrate, and the first end part is disposed as a shade structure. The seal comprises a second end part corresponding to the first end part, and seal body located between the first end part and the second end part; and the black matrix contacts directly the side of the first end part.

The present invention discloses a liquid crystal display device, which comprises: a liquid crystal display module, the liquid crystal display module further comprises a color filter substrate, a thin film transistor substrate and seal. The thin film transistor substrate and the color film substrate are disposed oppositely, and the seal is disposed between the thin film transistor substrate and the color film substrate. The color filter substrate further comprises a first glass substrate and a black matrix. The seal comprises a first end part contacting the first end part of the color filter substrate. No black matrix is disposed between the first end part and the color filter substrate, and the first end part is disposed as a shade structure.

The efficacy of the present invention is that to be distinguished from the state of the art. The liquid crystal display module and the liquid crystal display device according to the present invention provide the advantages of being convenient for seal curing, facilitating narrow border design, avoiding aggravating the delay of drive signal, and so on.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic cross-sectional view showing the structure of a liquid crystal display module according to the present invention.

### DETAILED DESCRIPTION OF THE PREFERRED EMBODIMENTS

The following provides a clear and complete description of the technical solution according to the present invention using the drawing and the embodiment. Apparently, the drawings described below show only example embodiments of the present invention, instead of all embodiments. For other embodiments based on the disclosed drawings and embodiments, and obtained by those having ordinary skills in the art without paying any creative effort are also within the scope of the present invention.

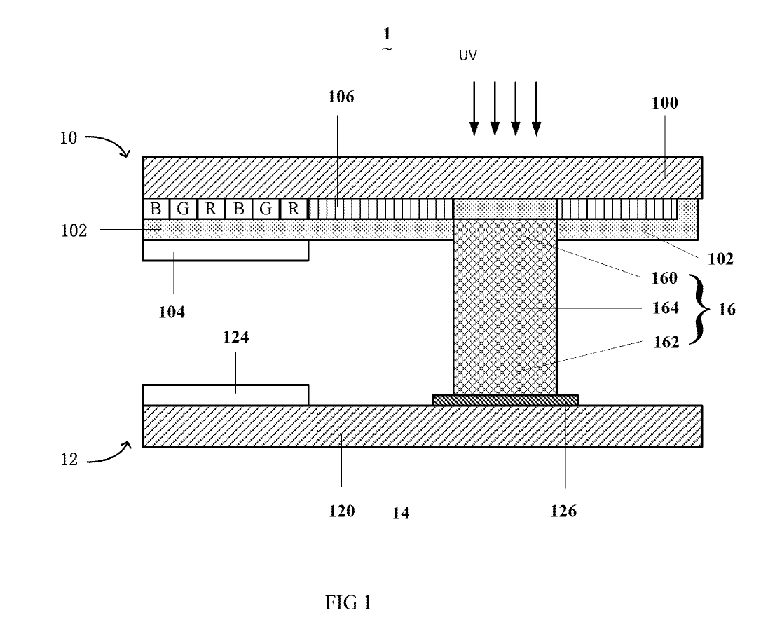

The present invention provides a liquid crystal display module, as shown in FIG. 1. Liquid crystal display module 1 comprises a color filter substrate 10, a color filter transistor substrate 12, a liquid crystal layer 14 and seal 16. Thin film transistor substrate 12 and color film substrate 10 are disposed oppositely, and seal 16 is disposed between thin film transistor substrate 12 and color film substrate 10, and seals liquid crystal layer 14 between thin film transistor substrate 12 and color film substrate 10.

Color filter substrate 10 further comprises an upper glass substrate 100, transparent conductive layer 102, upper active area 104 and black matrix 106.

Upper glass substrate 100 is a transparent substrate, for example, an alkaline glass, and is mainly for carrying. Upper active area 104 comprises a plurality of RGB pixel units (not shown). Transparent conductive layer 102 covers the RGB pixel units and black matrix 106. On border area of upper glass substrate 100, transparent conductive layer 102 is directly disposed on surface of upper glass substrate 100. Preferably, transparent conductive layer 102 is made of ITO or IZO.

Thin film transistor substrate 12 comprises a lower glass substrate 120, lower active area 124 and peripheral metal route 126.

Lower glass substrate 120 is a transparent substrate, for example, an alkaline glass, and is mainly for carrying. Lower active area 124 is located on surface of lower glass substrate 120 facing liquid crystal layer 14. Lower active area 124 corresponds to upper active area 104. Peripheral metal route 126 is disposed on surface of lower glass substrate 120 facing liquid crystal layer 14.

Seal 16 comprises a first end part 160, a second end part 162 and seal body 164. First end part 160 and second end part 162 are disposed oppositely, with seal body 164 located between first end part 160 and second end part 162.

First end part 160 contacts color filter substrate 10. Specifically, first end part 160 directly contacts transparent conductive layer 102. In other words, no black matrix 106 is disposed between first end part 160 and color filter substrate 10. Furthermore, black matrix 106 is located between active area 104 and first end part 160. In the present embodiment, black matrix 106 contacts directly first end part 160 on the side. In another embodiment, a space can exist between black matrix 106 and the side of first end part 160.

Second end part 162 contacts thin film transistor substrate 12, wherein peripheral metal route 126 is located between lower glass substrate 120 and second end part 162.

For letting UV light shine to cure seal 16 from the color filter substrate side, no black matrix 106 is disposed between seal 16 and upper glass substrate 100 so that UV light can pass through color filter substrate 10 to cure seal 16. To prevent UV light from partially leaking out of first end part 160 to affect the display effect, first end part 160 is disposed as a shade structure. In other words, after coating seal 16, seal 16 can receive UV light to cure. After curing, cured seal 16 can prevent UV light from leaking to serve the purpose of the black matrix in known technique.

The above describes first end part 160 as a shade structure. With this structure, second end part 162 can be an ordinary transparent structure or seal body 164 can also be a transparent structure. Both second end part 162 and seal body 164 can be transparent structure at the same time.

IN another embodiment, seal 16 can also be of other format. For example, in addition to first end part 160 as a shade structure, one of second end part 612 and seal body 164 can be a shade structure. Obviously, another alternative is to have all of first end part 160, second end part 162 and seal body 164 as shade structure. In other words, seal 16 can be a shade structure only partially or in entirety.

In the instant embodiment, all types of shade structure in seal 16 can be obtained by doping ordinary seal material with black dye.

The present invention further provides a liquid crystal display device (not shown). The liquid crystal display device comprises liquid crystal display module 1 and a backlight module (not shown) supplying light to liquid crystal display module 1.

The efficacy of the present invention is that to be distinguished from the state of the art. The liquid crystal display module and the liquid crystal display device according to the present invention provide the following advantages.

First, because no black matrix is disposed between seal and the upper glass substrate, a part of or an entirety of seal is used as a shade structure. During the manufacture process, the curing of seal can be performed directly from the color filter substrate side, and the cured seal can further. be used to function as a black matrix to prevent light leakage.

Then, because seal can be cured by UV from the color filter substrate side, it is not necessary to dispose slits in peripheral metal routes on the thin film transistor side to allow the UV light to pass. Therefore, the resistance of the peripheral metal route will not be increased to aggravate the drive signal delay.

Besides, because first end part of the seal can function as black matrix after curing, the distance between the edge of black matrix and edge of upper active area can be shortened. In other words, the border area surrounding upper active area can be shrunk to improve narrow border sign.

In summary, the liquid crystal display module and the liquid crystal display device according to the present invention provide the advantage of color filter substrate being convenient for seal curing, facilitating narrow border design, avoiding aggravating the delay of drive signal, and so on.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A liquid crystal display module, which comprises: a color filter substrate, a thin film transistor substrate and seal; the thin film transistor substrate and the color film substrate being disposed oppositely, and the seal being disposed between the thin film transistor substrate and the color film substrate; the color filter substrate further comprising a first glass substrate and a black matrix; the seal further comprising a first end part contacting the color filter substrate; no black matrix being disposed between the first end part and the color filter substrate, and the first end part being disposed as a shade structure.

2. The liquid crystal display module as claimed in claim 1, characterized in that the seal comprises a second end part corresponding to the first end part, and a seal body located between the first end part and the second end part; and the second end part contacts the thin film transistor substrate.

3. The liquid crystal display module as claimed in claim 2, characterized in that the second end part and the seal body are of shade structure.

4. The liquid crystal display module as claimed in claim 2, characterized in that at least one of the second end part and the seal body is of transparent structure.

5. The liquid crystal display module as claimed in claim 1, characterized in that the thin film transistor substrate comprises a second glass substrate and peripheral metal routes located between the second glass substrate and the second end part.

6. The liquid crystal display module as claimed in claim 1, characterized in that the color filter substrate comprises a first active area, and the black matrix is located between the first active area and the first end part.

7. The liquid crystal display module as claimed in claim 6, characterized in that the black matrix and the first end part contact each other directly, or are disposed oppositely with spacing.

8. The liquid crystal display module as claimed in claim 1, characterized in that the color filter substrate comprises a transparent conductive layer, the transparent conductive layer is disposed directly on surface of the first glass substrate, and the first end part directly contacts the transparent conductive layer.

9. A liquid crystal display module, which comprises: a color filter substrate, a thin film transistor substrate and seal; the thin film transistor substrate and the color film substrate being disposed oppositely, and the seal being disposed between the thin film transistor substrate and the color film substrate; the color filter substrate further comprising a first glass substrate and a black matrix; the thin film transistor substrate comprising a second glass substrate and peripheral metal routes located between the second glass substrate and the second end part; the seal further comprising a first end part contacting the color filter substrate, no black matrix being disposed between the first end part and the color filter substrate, and the first end part being disposed as a shade structure; the seal comprising a second end part corresponding to the first end part, and a seal body located between the first end part and the second end part; and the black matrix contacting directly the side of the first end part.

10. A liquid crystal display device, which comprises: a liquid crystal display module, the liquid crystal display module further comprising a color filter substrate, a thin film transistor substrate and seal; the thin film transistor substrate and the color film substrate being disposed oppositely, and the seal being disposed between the thin film transistor substrate and the color film substrate; the color filter substrate further comprising a first glass substrate and a black matrix; the seal comprising a first end part contacting the first end part of the color filter substrate; no black matrix being disposed between the first end part and the color filter substrate, and the first end part being disposed as a shade structure.

11. The liquid crystal display device as claimed in claim 10, characterized in that the seal comprises a second end part corresponding to the first end part, and a seal body located between the first end part and the second end part; and the second end part contacts the thin film transistor substrate.

12. The liquid crystal display device as claimed in claim 11, characterized in that the second end part and the seal body are of shade structure.

13. The liquid crystal display device as claimed in claim 11, characterized in that at least one of the second end part and the seal body is of transparent structure.

14. The liquid crystal display device as claimed in claim 10, characterized in that the thin film transistor substrate comprises a second glass substrate and peripheral metal routes located between the second glass substrate and the second end part.

15. The liquid crystal display device as claimed in claim 10, characterized in that the color filter substrate comprises a first active area, and the black matrix is located between the first active area and the first end part.

16. The liquid crystal display device as claimed in claim 15, characterized in that the black matrix and the first end part contact each other directly, or are disposed oppositely with spacing.

17. The liquid crystal display device as claimed in claim 10, characterized in that the color filter substrate comprises a transparent conductive layer, the transparent conductive layer is disposed directly on surface of the first glass substrate, and the first end part directly contacts the transparent conductive layer.
